(19) United States
(12) Patent Application Publication
(10) Pub. No.: US 2025/0256213 A1
(43) Pub. Date: Aug. 14, 2025

(54) MODULAR TOY

(71) Applicant: LEGO A/S, Billund (DK)

(72) Inventors: Peter DE FINE LICHT, Billund (DK); Hans Jessen ANDERSEN, Billund (DK); Ruben ROMIJNDERS, Billund (DK)

(73) Assignee: LEGO A/S, Billund (DK)

(21) Appl. No.: 18/857,666

(22) PCT Filed: Apr. 27, 2023
(86) PCT No.: PCT/EP2023/061078

§ 371 Date: Oct. 17, 2024

(30) Foreign Application Priority Data
Apr. 27, 2022 (DK) PA202270222

(51) Int. Cl. A63H 7/04; A63F 7/06; A63F 9/16; A63H 1/20; A63H 17/00

(52) U.S. Cl. CPC A63H 7/04; A63F 7/0632; A63F 7/064; A63F 9/16; A63H 1/20; A63H 17/002

(57) ABSTRACT

The invention relates to a modular toy including a toy figurine and a cart body. The cart body has a hub portion with an upper side, a lower side, and a side surface. Further, the toy figurine is releasably attachable to the upper side of the hub portion such that the toy figurine is non-rotationally attached to the cart body. Three or more sphere connectors extend radially from the side surface of the hub portion. Each sphere connector is configured for releasably attaching a spherical body such that when a spherical body is attached to the sphere connector, the spherical body is rotatable relative to the sphere connector. The sphere connectors are arranged such that the center of the spherical bodies attached to the sphere connectors are in the same plane parallel to the lower surface of the hub portion.

### CROSS-REFERENCE TO RELATED APPLICATIONS

The present application is a U.S. National Stage Application of International Application No. PCT/EP2023/061078 filed on Apr. 27, 2023, published on Nov. 2, 2023 as WO 2023/209072 A1, and entitled MODULAR TOY, which claims the benefit and priority of Danish Patent Application No. PA202270222, filed on Aug. 27, 2022, each of which is incorporated herein by reference in its entirety for any purpose whatsoever.

### FIELD OF THE DISCLOSURE

The present disclosure relates to toys, and more particularly to modular toys.

### BACKGROUND

GB2134397 A discloses a toy car with two parallel wheels and a ball rotatably retained by an arch-shaped recess.

US 2007/0205554 A1 discloses a jousting element for use in a game. The jousting element has a body which is arranged around a cylindrically aligned vertical axis. The body is configured to rotate about the vertical axis and to be carried above a playing surface. A traveling component connected to the body enables the body of the jousting element to be carried above the playing surface along multiple directions of travel. Attached to the body is a first playing component. The first playing component enables the jousting element to engage a second jousting element.

WO 82/03335 discloses a rollable toy having a body with axles having rollable members at their ends. An axle has a stepped, resilient, headed male portion and a female portion with which it mates, each portion having an outer socket for receiving a boss on a spherical hollow wheel member. The wheel member may have loose contents for creating a sound during rolling. A face member may be mounted on the body.

Modular toys in the form of e.g. carts are known in the art. Toy carts may cost efficiently be formed in a polymer material, typically injection moulded plastics. Such toy carts are often light weight, which affects their rolling performance. Further, such toy carts, even modular toy carts, are often very limited in their function. There is thus a need in the art for a versatile modular toy, where the rolling performance of a cart body of the modular toy is improved, so that also the play options are increased.

### SUMMARY

It is therefore an object of the disclosure to increase the variety of play options.

This is achieved by a modular toy comprising
a toy figurine; and
a cart body;
   wherein the cart body comprises
a hub portion having an upper side, a lower side, and a side surface, the toy figurine being releasably attachable to the upper side of the hub portion, such that the toy figurine is non-rotationally attached to the cart body; and
three or more sphere connectors extending radially from the side surface of the hub portion,
wherein each sphere connector is configured for releasably attaching a spherical body, such that when a spherical body is attached to the sphere connector, the spherical body is rotatable relative to the sphere connector, and
wherein the sphere connectors are arranged such that the centre of the spherical bodies attached to the sphere connectors are in the same plane parallel to the lower side of the hub portion.

By “non-rotationally attached” is meant that when attached the toy figurine is prevented from rotation relative to the cart body.

The non-rotationally attachment of the toy figurine allows a user easily manipulate the cart, for example spinning it.

The spherical bodies are preferably releasably attached in the sphere connectors in a snap connection. The snap connection is preferably provided by the material of the sphere connectors being slightly flexible, and/or by a shape of an inner surface of the sphere connectors.

The connection between the sphere connector and a sphere body is configured such that the sphere body is freely rotatable relative to the sphere connector, and thereby to the cart body.

Due to the spherical bodies being freely rotatable in all directions relative to the sphere connectors, when sphere bodies are attached in each sphere connector of the cart body, the toy cart may roll in any direction on a surface on which it is placed. Thereby, the play options are increased, as the toy figurine may be transported in unlimited paths.

Preferably, the spherical bodies are all of equal size, i.e. they have the same radius. The radius of the spherical bodies and the dimensions of the cart are arranged such that, when a spherical body is attached in each of the sphere connectors, and the spherical bodies rest on a planar surface, e.g. a floor or a table, the lower side of the hub portion is lifted above that planar surface. Further, in that situation, all other portions of the cart are lifted above that surface.

The spherical bodies may be marbles, such as stone marbles or glass marbles. However, they may also be formed in other materials such as metal or in principle polymers. In preferred embodiments the spherical bodies are formed in a “heavy” material, such that the cart of the toy may—when pushed or rotated—obtain more momentum, which affects its rolling properties.

Each of the sphere connectors of the toy are, in preferred embodiments, configured for attaching spherical bodies having the same diameter.

The sphere connectors may be generally ring-shaped structures, where the inner surface of the ring shaped structure has a concavity configured to hold the spherical body. In further embodiments the sphere connectors may be generally ring-shaped structures having identical inner diameters, such that they are configured to attach spherical bodies having equal diameters.

In an embodiment, the toy may further comprise a spherical body for each sphere connector. Thus, if the cart has three sphere connectors, the toy comprises at least three spherical bodies, and if the cart has four sphere connectors, the toy comprises at least four spherical bodies.

In an embodiment, the toy figurine is releasably attachable to the upper surface of the hub portion by the upper surface being provided with coupling means of a first type, and by a lower surface of the toy figurine being provided with coupling means of a second type, where the coupling means of a first type and the coupling means of a second type are mutually corresponding.

In an embodiment thereof, the non-rotational attachment of the toy figurine to the hub portion is provided by two spaced apart coupling means of a first type on the upper side of the hub portion, and the lower surface of the toy figurine being provided with two equidistantly arranged coupling means of the second type.

In some embodiments thereof, the coupling means of a first type may be provided by a particular cross sectional shape of the legs or feet of the toy figurine, and where the coupling means of a second type may be provided by corresponding openings provided in the upper surface of the hub portion of the cart, the openings having a cross sectional shape cooperating with the shape of the coupling means of the second type. Thereby, the toy figurine may be loosely attached to the cart in the sense that the cooperating shapes prevents movement of the toy figurine relative to the cart in any direction in a plane parallel to the above mentioned first plane, thereby allowing manipulation (spinning, liner movement, etc.) of the cart though the toy figurine, and allowing movement in a direction perpendicular to the first plane. Thereby, the toy figurine can very easily be attached to and removed from the cart, and further the toy figurine may be ejected from the cart, for example on impact with another object.

Alternatively, and in a preferred embodiment, the coupling means are knobs, and the coupling means of the second type are knob-receiving openings. Such coupling means are known in the art, and allows attachment via a press fit.

The toy in these embodiments may for example be used in games, where a number of users, each having a copy of the toys, may compete in getting as close as possible to an edge of a surface, such as a table, without falling over the edge. Users may also compete in a petanque (boule) or curling-like game where the object is to get as close as possible to a given point or line on a planar surface. The ability of the toy to spin and slide may increase the complexity of the game. A toy may also be used in an “air hockey” type game, where two users opposing each other pushes the toy from side to side between them.

In either of the above embodiments, the toy may further comprise a spinning element, the spinning element being releasably attachable to the hub portion at the lower side thereof, the spinning element having an upper surface and a lower convex surface and a first height, wherein the first height is such that when the spinning element is attached to the hub portion, and the toy is rested on a planar surface, a maximum of two of the spherical bodies rest on the planar surface.

This means that if the toy is spun, for example by manipulating the toy figurine, all of the spherical bodies will elevate from the surface on which the toy is spun, and will function as a classical spinning toy. The weight of the spherical bodies will add momentum and prolong the spinning of the toy. Thereby, when the spinner element is attached, additional play options are added. For example, two or more users each having a toy according to this embodiment may let their toy figurines battle against each other in spinning battels.

In any of the above embodiments either the toy figurine, or the cart, or both, may be provided with coupling means of a third kind, configured to attach another object such as a toy spear, a toy sword or a toy flag.

The first height is defined between the upper surface and the lower convex surface of the spinning element.

In an embodiment, the spinning element is releasably attachable to the lower side of the hub portion by the upper surface of the spinning element being provided with coupling means of a first type, and the lower side of the hub portion being provided with coupling means of a second type, and where the coupling means of a first type and the coupling means of a second type are mutually corresponding.

In a further embodiment, the coupling means of the first type are knobs, and the coupling means of the second type are knob-receiving openings.

In further embodiments, the embodiments relating to releasably connecting the toy figurine to the hub portion of the cart, and the embodiments for connecting the spinning element to the hub portion of the cart may be combined, such that the same coupling means of the first type and the same coupling means of the second types are used for both sets of embodiments.

The combination of the cart body with sphere bodies attached in the sphere connectors, and a spinner element attached to the cart body, allows the use of the cart as a spinner/spinning top, where the sphere bodies provide weight to the spinner by providing a momentum when spun. Attaching a toy figurine to the cart body allows an easy way for a user to spin the assembly and thereby an improved spinning top/spinner is provided. Further, the toy figurine being attached to the cart and spinning element allows the modular toy to appear like a spinning person, for example a fighting ninja. This is cool.

In further embodiments, the spinning element comprises a spacer element and spinner tile, where the spacer element is connectable at one end to the lower side of the hub portion and at an opposite end to the spinner tile, and where the convex surface of the spinning element is the lower surface of the spinner tile.

In a further embodiment, thereof the spacer element is cylindrical in shape and has tubular element rotationally attached on an outside surface of the spacer element. Thereby, the tubular element may be rotationally connected relative to the cart.

This tubular element may be provided with one or more coupling means of a third kind, configured to attach another object such as a toy spear, a toy sword or a toy flag. Thereby, flags, swords or spears may for example be brought to rotate in a different direction than the cart, or in the same direction, but with a different rotational speed.

In either of the above embodiments, the sphere connectors may be ring shaped, and wherein an inner surface of the ring-shaped sphere connector is provided with an annular cavity corresponding to an arc of the spherical body.

In either of the above mentioned embodiments the toy figurine, or any subcomponent thereof is preferably formed in a polymer material, such as a plastic. The toy figurine, or any subcomponent, may be formed in an injection moulding process.

In either of the above mentioned embodiments the hub portion and the sphere connectors may be formed as one integrated unit, and preferably in a polymer material, such as a plastic. Thereby the cart body of the cart may be formed in an injection moulding process.

It should be emphasized that the term “comprises/comprising/comprised of” when used in this specification is taken to specify the presence of stated features, integers, steps or components but does not preclude the presence or addition of one or more other features, integers, steps, components or groups thereof.

### BRIEF DESCRIPTION OF THE DRAWINGS

It should be appreciated that the subject technology can be implemented and utilized in numerous ways, including without limitation as a process, an apparatus, a system, a device, a method for applications now known and later developed. So that those having ordinary skill in the art to which the disclosed technology appertains will more readily understand how to make and use the same, reference may be had to the following drawings. It should be emphasized that the embodiments shown are used for example purposes only and should not be used to limit the scope of the disclosure.

FIG. 1, in a perspective view, shows a modular toy according to one embodiment of the disclosure, the modular toy comprising a toy figurine and a cart with three spherical bodies;

FIG. 2A, in a perspective view, shows a modular toy according to another embodiment of the disclosure, the modular toy comprising a toy figurine and a cart with three spherical bodies;

FIG. 2B, in a perspective view, shows a cart body of the cart shown in FIG. 2A, and with three spherical bodies for a toy, the cart comprising coupling means of a first type;

FIG. 3, in perspective view shows a toy figurine for a toy according to the disclosure, the toy figurine having coupling means of a second type complementary with coupling means of a first type;

FIG. 4A, in a perspective view from below, shows a prior art modular construction element, the modular construction element having coupling means of a first type—in the form of knobs—formed on one surface and coupling means of a second type—knob receiving openings—on an opposite surface;

FIG. 4B, in a see-through perspective view from above, shows the prior art modular construction element of FIG. 4A;

FIG. 5, in a cross sectional side view, shows a cart for a toy according to yet an embodiment of the disclosure;

FIG. 6A, in a cross sectional side view, shows the cart of FIG. 5 with a spinning element attached thereto

FIG. 6B, in a cross sectional side view, shows the cart of FIG. 5 with a spinning element detached therefrom;

FIG. 7A, in a cross sectional side view, shows the cart of FIG. 5 with a spinning element attached thereto, where the spinning element is constructed from two modular construction elements, a spacer element and a spinner tile; and

FIG. 7B shows the cart of FIG. 7B, with the spacer element and the spinner tile of the spinning element detached from the cart and from each other.

### DETAILED DESCRIPTION

The subject technology overcomes many of the prior art problems associated with modular toys. The advantages, and other features of the technology disclosed herein, will become more readily apparent to those having ordinary skill in the art from the following detailed description of certain preferred embodiments taken in conjunction with the drawings which set forth representative embodiments of the present technology and wherein like reference numerals identify similar structural elements. Directional indications such as front, back, upward, downward, right, left and the like are used with respect to the figures and not meant in a limiting manner.

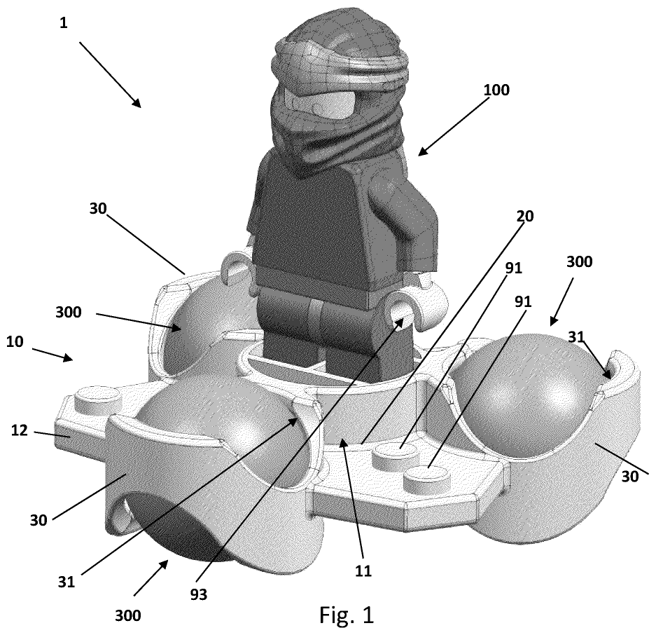

FIG. 1A shows one embodiment of modular toy 1 according to the disclosure, and FIG. 1B show another. The two embodiments are almost identical, apart from a few detail, which will be mentioned below. In either embodiment, the modular toy 1 comprises a toy figurine 100 and a cart 10. The toy figurine 100 is releasably attachable to the cart 10 as describe further below. Thus, the toy figurine 100 may be used with ether cart 10 and vice versa.

The cart 10 comprises a cart body 11 and three spherical bodies 300 attached thereto. The spherical bodies 300 are releasably attachable to the cart 10, so that they may be replaced or interchanged. The spherical bodies 300 may for example be provided with patterns or have different colours. Having a larger number of spherical bodies 300 than being attachable to the cart at the same time will allow a user to customize the cart.

The cart body 11 comprises a hub portion 20 and three sphere connectors 30 extending radially outwards from the hub portion 20, the sphere connectors 30 being arranged in a plane, and in the same plane as the hub. Thus, the cart body 11 is a generally flat structure.

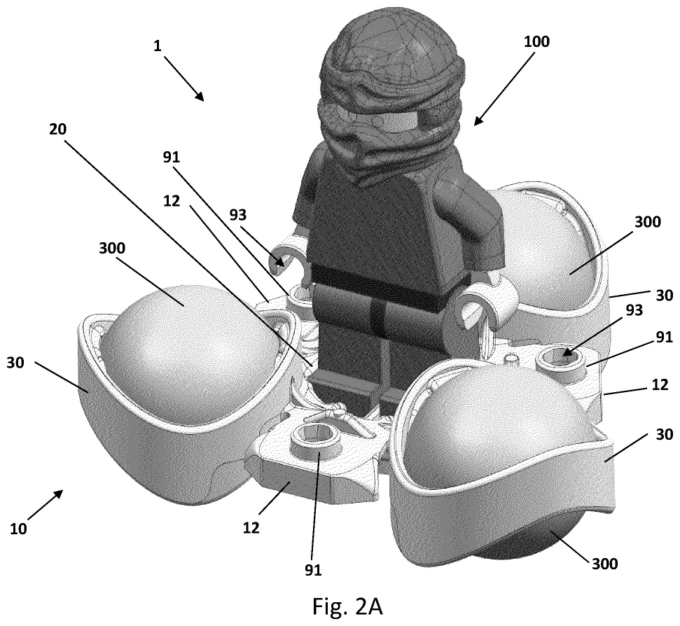

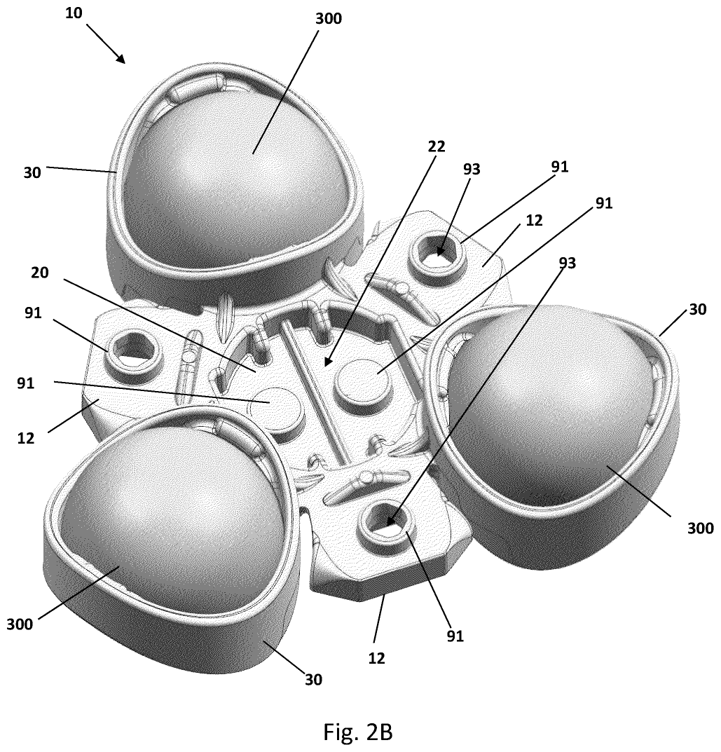

Referring also to FIG. 2 and e.g. FIG. 6A, the hub portion 20 comprises, body 21 having an upper side 22, a lower side 23, opposite to the upper side 22, and a side surface 24.

The toy figurine 100 is releasably attachable to the upper side 22 of the hub portion 20.

The three sphere connectors 30 extend radially from the side surface 24 of the hub portion 20.

The sphere connectors 30, and the hub portion 20 are preferably formed integral as a unit. However, in some not shown embodiments, the sphere connectors may be releasably attached to the hub portion 20. This may be made possible by the sphere connectors 30 and the hub portion 20 being provided with suitable complimentary coupling means.

As shown in FIG. 1A, plate sections 12 may extend radially outwards from the hub portion 20 between the sphere connectors 30. Such plate sections 12 are optional. On an upper surface of the plate sections 12 in FIG. 1A, coupling means of a first type 91—in the form of knobs (or studs)—are provided. These may be used to attach further modular toy construction elements to the cart 10. Coupling means of a first type 91 (knobs/studs) are discussed in more detail below. In FIG. 1A, two knob type coupling means of a first type 91 are provided on each plate section 12.

The embodiment shown in FIGS. 1B and FIG. 2, also comprises plate sections 12. Also these plate sections 12 extends radially outwards from the hub portion 20 between the sphere connectors 30, but in this embodiment, the plate sections 12 are not connected to outer surfaces of the sphere connectors, as is the case in the FIG. 1A embodiment.

Also in the FIG. 1B embodiment, coupling means of a first type 91—in the form of knobs (or studs)—are provided on an upper surface of the plate sections 12. Again these may be used to attach further modular toy construction elements to the cart 10. In FIG. 1B, one knob type coupling means of a first type 91 are provided on each plate section 12.

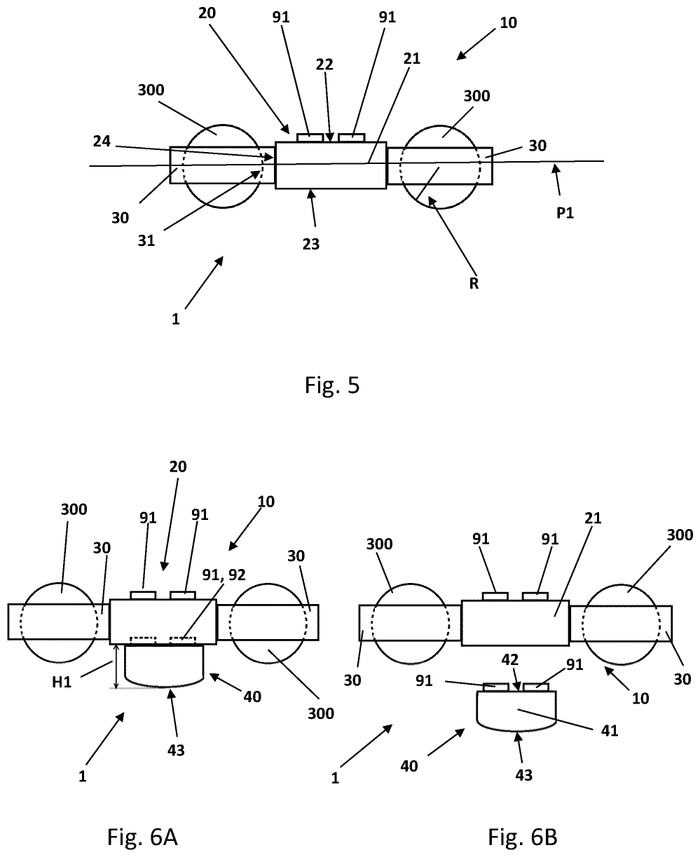

It will be realized, that in other embodiments there may be more than three sphere connectors 30. For example, FIGS. 6A-B are sections through an embodiment (FIG. 5) having four sphere connectors 30 arranged equidistantly along the periphery of the hub portion 20 (90° apart).

It is noted that the three sphere connectors 30 in the FIG. 1A and FIG. 1B embodiments are also arranged equidistantly along the periphery of the hub portion 20, (120° apart).

In either case, each sphere connector 30 is configured for releasably attaching a spherical body 300.

Further, the releasable attachment of each spherical body to a sphere connector 30 is such that when a spherical body 300 is attached to the sphere connector 30, the spherical body 300 is rotatable relative to the sphere connector 30 in all directions.

As shown in FIG. 5, the sphere connectors 30 are arranged such that the centre of the spherical bodies 300, when attached to the sphere connectors 30, are in same first plane P1, which is arranged in parallel to a plane defined by the lower side 23 of the hub portion 20.

The upper surface 22 of the hub portion 20 is also parallel to the lower side 23 of the hub portion 20, and therefore to the first plane P1.

The spherical bodies 300 are preferably all of equal size, i.e. they have the same radius, R. The radius of the spherical bodies 300 and the dimensions of the cart 10 are arranged such that, when a spherical body 300 is attached in each of the sphere connectors 30, and the spherical bodies 300 rest on a planar surface, e.g. a floor or a table, the lower side 23 of the hub portion is lifted above that planar surface. Further, in that situation, all other portions of the cart 10 are lifted above that surface, as shown in FIG. 5. Thereby, due to the free rotation of the spherical bodies in the sphere connectors 30 the cart may move unimpeded in every direction on a surface on which it is placed.

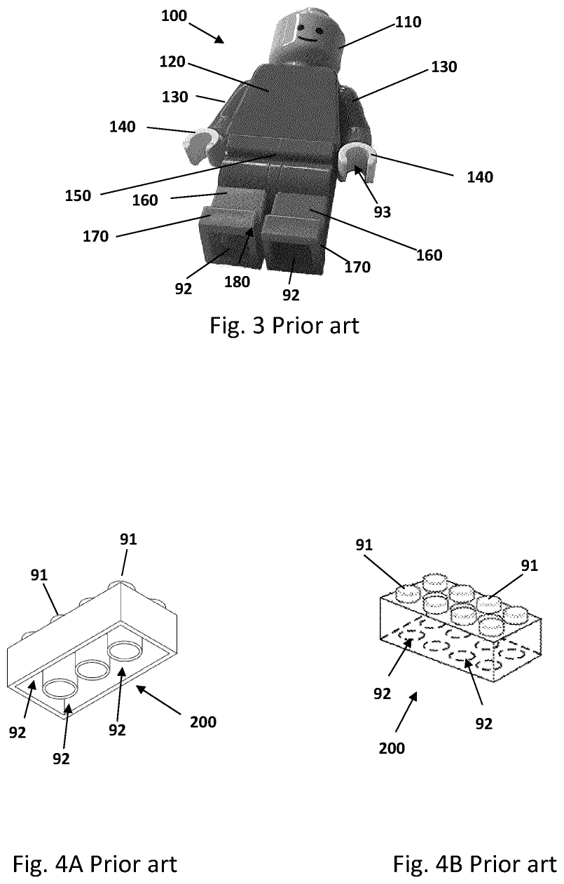

Now referring to FIG. 3, the toy figurine 100 is a figure representing a humanoid. The toy figurine comprises a head 110 extending from an upper body 120, to which arms 130 are attached on each side. In the shown example (FIGS. 1 and 3), the head is rotatable relative to the upper body 120, and releasable attached thereto. Further, each arm is rotatable relative to the upper body 120, and releasable attached thereto. A hand 140 may be provided in extension of each arm 130. Each hand 140 is rotatable relative to the arm 130, and releasable attached thereto.

Each hand 140 may be shaped in a U shape, such that the hand 140 provides a coupling means of a third kind 93 for coupling a rod shaped element thereto in a snap fit connection. Thereby, the hand 140 may be configured to attach another object (not shown), such as a toy spear, a toy sword or a toy flag.

The toy figurine 100 further comprises a lower body portion 150, which is releasably attached to the upper body 120. Two legs 160 are attached to the lower body independently rotatable to the lower body 150. A foot 170 is formed in extension of each leg 160.

The toy figurine 100 further has a lower surface 180, in this embodiment provide at the bottom of the feet 170.

The toy figurine 100 is releasably attachable to the upper surface 22 of the hub portion 20 by the upper surface 22 being provided with coupling means of a first type 91 which are configured for cooperating with coupling means of a second type 92 provided on the lower surface 180 of the toy figurine 100.

In some embodiments and as exemplified in FIG. 1A, the coupling means of a first type may be provided by a particular cross sectional shape of the legs 160 or feet 170 of the toy figurine 100, and where the coupling means of a second type may be provided by corresponding openings provided in the upper surface of the hub portion 20 of the cart 10, the openings having a cross sectional shape cooperating with the shape of the coupling means of the second type. Thereby, the toy figurine 100 may be loosely attached to the cart 10 in the sense that the cooperating shapes prevents movement of the toy figurine 100 relative to the cart 10 in any direction in a plane parallel to the above mentioned first plane, P1, thereby allowing manipulation (spinning, liner movement, etc.) of the cart 10 though the toy figurine 100, and allowing movement in a direction perpendicular to the first plane, P1. Thereby, the toy figurine 100 can very easily be attached to and removed from the cart 10, and further the toy figurine 100 may be ejected from the cart, for example on impact with another object.

However, as shown in FIG. 1B and FIG. 2, preferably the coupling means 91 for releasably attaching the toy figurine 100 to the upper surface 22 of the hub portion 20 are knobs, and as shown in FIG. 3 the coupling means of the second type 92 are knob-receiving openings.

Further as shown in FIG. 2 two knobs are provided as coupling means of the first type 91. When the toy figurine 100 is attached via the knob receiving openings, i.e. coupling means of the second type 92, formed in the lower surface 180 of the toy figurine, which are distanced from each other by the same distance as the two knobs on the upper surface 22 of the hub portion 20, the toy figurine will be non-rotational attached to the hub portion 20. It will be realized that the same result is achieved by the coupling in FIG. 1A.

The coupling between various objects using knobs and knob receiving openings is well known in the art from modular construction elements 200 such as shown in FIG. 4A-B.

Now, referring to FIGS. 6A-B, the modular toy 1 further comprises a spinning element 40. The spinning element 40 is releasably attachable to the hub portion 20 at the lower side 23 thereof.

The spinning element 40 comprises a body portion 41 having an upper surface 42, a lower convex surface 43, and a first height, H1.

The first height, H1 is defined between the upper surface 42 and the lowermost point of the lower convex surface 43 of the spinning element 40. (when the spinning element 40 is oriented as shown in the drawings with the first coupling means 91 extending upwards).

The first height, H1, is such that when the spinning element 40 is attached to the hub portion 20, and the toy 1 is rested on a planar surface, a maximum of two of the spherical bodies 300 rest on the planar surface.

This means that if the toy 1 is spun, for example by manipulating the toy figurine 100, all of the spherical bodies 300 will elevate from the surface on which the toy 1 is spun, and will function as a classical spinning toy.

The releasable attachment of the spinning element 40 to the lower side 23 of the hub portion 20 is provided by the upper surface 42 of the spinning element 40 being provided with coupling means of a first type 91, and the lower side 23 of the hub portion 20 being provided with coupling means of a second type 92, not shown. As indicated in FIGS. 6A-B, the coupling means of the first type 91 are preferably knobs, and the coupling means of the second type 92 are cooperating knob-receiving openings. In other embodiments other types of couplings may be utilized.

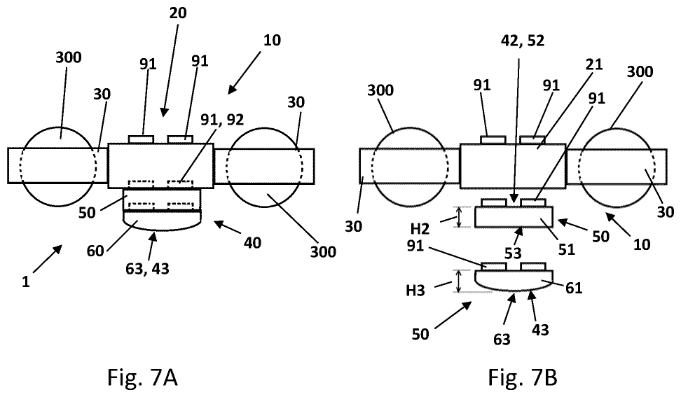

In embodiments shown in FIGS. 7A-B, the spinning element 40 is formed by a combination of sub-elements. In one embodiment, the spinning element 40 comprises a spacer element 50 and spinner tile 60, attachable thereto. The spacer element 50 comprises a body 51 having height H2 from an upper side 52 to a lower side 53. The spacer element 50 is connectable at one end, the upper side 52 to the lower side 23 of the hub portion 20. The upper side 52 of the spacer element 50 may be provided with first type coupling means 91 for example in the form of knobs, and the lower side 23 of the hub portion 20, may as already described above be provided with knob receiving openings (second type coupling means 92). The opposite end, the lower side 53 of the spacer element 50 is releasably attachable to the spinner tile 60. The spinner tile 60 comprises a body 61, having a height, H3, between an upper side 62 and a lower side 63. The upper side 62 of the spinner tile 60 may be provided with first type coupling means 91 for example in the form of knobs as shown in FIGS. 6A-B, such that when the lower side 53 of the spacer element 50 is provided with second type coupling means 92 in the form of knob receiving openings, a releasable attachment between the spacer element 50 and the spinner tile 60 is provided. The lower side 53 of the spinner tile is convex. In such embodiments the convex surface 63 spinner tile 60 forms the convex surface 43 of the spinning element 40, when the spacer element 50 and the spinner tile 60 are connected to form a spinning element 40. It will be appreciated that the third height, H3 is defined between the upper surface 62 and the lowermost point of the lower convex surface 63 of the spinning tile 60. (when the spinning tile 60 is oriented as shown in the drawings with the first coupling means 91 extending upwards).

In further, not shown embodiments, the spacer element 50 is cylindrical in shape and has tubular element rotationally attached on an outside surface thereof.

As shown in FIGS. 1A, 1B, 2 and 6A, the sphere connectors 30 may be ring shaped, where an inner surface 31 of the ring-shaped sphere connector is provided with an annular cavity—or concave surface—which corresponds in shape to an arc of the spherical body 300 to be attached in the sphere connector 30.

It will be appreciated by those of ordinary skill in the pertinent art that the functions of several elements may, in alternative embodiments, be carried out by fewer elements, or a single element. Similarly, in some embodiments, any functional element may perform fewer, or different, operations than those described with respect to the illustrated embodiment. Also, functional elements shown as distinct or integral for purposes of illustration may be incorporated within other functional elements or separated into multiple components in a particular implementation. Further, although the subject technology has been described with respect to modular toys, it is envisioned that the subject technology would be equally applicable to other devices.

While the subject technology has been described with respect to preferred embodiments, those skilled in the art will readily appreciate that various changes and/or modifications can be made to the subject technology and claims without departing from the spirit or scope of the disclosure. For example, each claim may depend from any or all claims in a multiple dependent manner even though such has not been originally claimed and various components and features may be added into other claims or removed from the original claims. Reference numerals in the claims are only for illustration and not limiting with respect to other embodiments, structures and versions.

### LIST OF PARTS

1 toy
10 cart
11 cart body
12 plate sections extending from cart body and between adjacent sphere connectors
20 hub portion of cart
21 body of hub portion
22 upper side of hub portion/body of hub portion
23 lower side of hub portion/body of hub portion
24 side surface of hub portion/body of hub portion
30 sphere connector
40 spinning element
41 body/body portion of spinning element
42 upper surface of spinning element
43 lower, concave surface of spinning element
50 spacer element
51 body of spacer element
52 upper side of body of space element
53 lower side of body of spacer element
60 spinner tile
61 body of spinner tile
62 upper side of spinner tile
63 lower, concave surface of spinner tile
91 coupling means of first type
92 coupling means of second type
93 coupling means of third type
100 toy figurine
110 head of toy figurine
120 upper body of toy figurine
130 arms of toy figurine
140 hands of toy figurine
150 lower body of toy figurine
160 leg of toy figurine
170 foot of toy figurine
180 lower surface of toy figurine
200 modular construction element (prior art)
300 spherical body
H1 first height, height of spinning element
H2 second height, height of distance element
H3 third height, height of spinner tile
R Radius of spherical body

1. A modular toy comprising
a toy figurine; and
a cart body;
wherein the cart body comprises
a hub portion having an upper side, a lower side, and a side surface, the toy figurine being releasably attachable to the upper side of the hub portion, such that the toy figurine is non-rotationally attached to the cart body ; and
three or more sphere connectors extending radially from the side surface of the hub portion,
wherein each sphere connector is configured for releasably attaching a spherical body, such that when a spherical body is attached to the sphere connector, the spherical body is rotatable relative to the sphere connector,
wherein the sphere connectors are arranged such that a center of the spherical bodies attached to the sphere connectors are in a same plane parallel to the lower side of the hub portion, and
wherein the sphere connectors are configured such that the spherical bodies are freely rotatable relative to the sphere connector in all directions.

2. The modular toy according to claim 1, wherein the toy figurine is releasably attachable to the upper surface of the hub portion by the upper surface being provided with coupling means of a first type, and a lower surface of the toy figurine being provided with coupling means of a second type, and where the coupling means of a first type and the coupling means of a second type are mutually corresponding.

3. The modular toy according to claim 2, wherein the non-rotational attachment of the toy figurine to the hub portion is provided by two spaced apart coupling means of the first type on the upper side of the hub portion, and the lower surface of the toy figurine being provided with two equidistantly arranged coupling means of the second type.

4. The modular toy according to claim 2, wherein the coupling means of the first type are knobs, and where the coupling means of the second type are knob-receiving openings.

5. The modular toy according to claim 1, further comprising a spinning element releasably attachable to the hub portion at the lower side thereof, the spinning element having an upper surface and a lower convex surface and a first height,
wherein the first height is such that when the spinning element is attached to the hub portion, and the toy His rested on a planar surface, a maximum of two of the spherical bodies rest on the planar surface.

6. The modular toy according to claim 5, wherein the spinning element is releasably attachable to the lower side of the hub portion by the upper surface of the spinning element being provided with coupling means of the first type, and the lower side of the hub portion being provided with coupling means of the second type, and where the coupling means of the first type and the coupling means of the second type are mutually corresponding.

7. The modular toy according to claim 6, wherein the coupling means of the first type are knobs, and where the coupling means of the second type are knob-receiving openings.

8. The modular toy according to claim 5, wherein the spinning element comprises a spacer element and spinner tile, where the spacer element is connectable at one end to the lower side of the hub portion and at an opposite end to the spinner tile, and where the convex surface of the spinning element is the lower surface of the spinner tile.

9. The modular toy according to claim 6, wherein the spacer element is cylindrical in shape and has tubular element rotationally attached on an outside surface thereof.

10. The modular toy according to claim 1, wherein the sphere connectors are ring shaped, and wherein an inner surface of the ring-shaped sphere connector is provided with an annular cavity corresponding to an arc of the spherical body.

11. The modular toy according to claim 1, wherein the hub portion and the sphere connectors are formed as an integral unit.

12. The modular toy according to claim 1, wherein the sphere connectors are detachably attached to the hub portion.

13. A modular toy comprising:
a toy figurine; and
a cart body, the cart body having:
a hub portion with an proximal side, a distal side, and a side surface, the toy figurine being attachable to the proximal side of the hub portion such that the toy figurine cannot rotate when attached; and
three sphere connectors extending radially from the side surface of the hub portion, each sphere connector configured for attaching a spherical body such that the spherical bodies are freely rotatable relative to the sphere connector in all directions, the sphere connectors arranged such that a center of the spherical bodies attached to the sphere connectors are in a same plane parallel to the distal side of the hub portion.

14. The modular toy according to claim 13, further comprising a spinning element releasably attachable to the hub portion on the distal side thereof, the spinning element having a proximal surface and a distal convex surface and a first height,
wherein the first height is such that when the spinning element is attached to the hub portion, and the toy is rested on a planar surface, a maximum of two of the spherical bodies rest on the planar surface.

15. The modular toy according to claim 14, wherein the spinning element comprises a spacer element and spinner tile, wherein the spacer element is connectable at one end to the distal side of the hub portion and at an opposite end to the spinner tile, and wherein the convex surface of the spinning element is the distal surface of the spinner tile.

16. The modular toy according to claim 15, wherein the spacer element is cylindrical in shape and has tubular element rotationally attached on an outside surface thereof.

17. The modular toy according to claim 13, wherein the sphere connectors are ring shaped, and wherein an inner surface of the ring-shaped sphere connector is provided with an annular cavity corresponding to an arc of the spherical body.

18. The modular toy according to claim 13, wherein the hub portion and the sphere connectors are formed as an integral unit.

19. The modular toy according to claim 13, wherein the sphere connectors are detachably attached to the hub portion.

20. A modular toy comprising:
a cart having:
a cart body configured for receiving a toy figurine, the cart body extending along a cart body plane; and
three sphere connectors extending radially from the cart body, each sphere connector configured for releasably attaching a rotatable spherical body, the spherical body arranged in the sphere connectors such that such that a center of the spherical bodies are aligned in the cart body plane.
